(19) United States
(12) Patent Application Publication
(10) Pub. No.: US 2021/0070267 A1
(43) Pub. Date: Mar. 11, 2021

(54) ELECTROHYDRAULIC VEHICLE POWER BRAKING SYSTEM FOR AN AUTONOMOUSLY DRIVING LAND VEHICLE

(71) Applicant: Robert Bosch GmbH, Stuttgart (DE)

(72) Inventors: Andreas Weh, Sulzberg (DE); Juergen Tandler, Fuessen (DE); Matthias Mayr, Rettenberg (DE); Thomas Weitze, Eberdingen (DE)

(21) Appl. No.: 16/957,481

(22) PCT Filed: Dec. 6, 2018
(86) PCT No.: PCT/EP2018/083834

§ 371 Date: Jun. 24, 2020

(30) Foreign Application Priority Data
Feb. 15, 2018 (DE) 10 2018 202 287.9

(51) Int. Cl. B60T 8/40; B60T 13/68

(52) U.S. Cl. CPC B60T 8/4081; B60T 13/662; B60T 13/686

(57) ABSTRACT

An electrohydraulic vehicle power braking system for a passenger car driving autonomously on public roads. Two power brake pressure generators are provided which are independent of one another, one of which preferably includes an electromechanically drivable power piston-cylinder unit, and the other preferably includes two hydraulic pumps. Each power brake pressure generator includes a brake fluid reservoir, which is divided into chambers and which together are connected to a further brake fluid reservoir, which is not divided into chambers. The further brake fluid reservoir includes a brake fluid sensor, with the aid of which a brake fluid loss due to a leak at any arbitrary point of the vehicle power braking system is establishable. Due to short lines, the brake fluid reservoirs cause low flow resistances, and thus a rapid brake pressure build-up, even when the brake fluid is cold and, as a result, viscous.

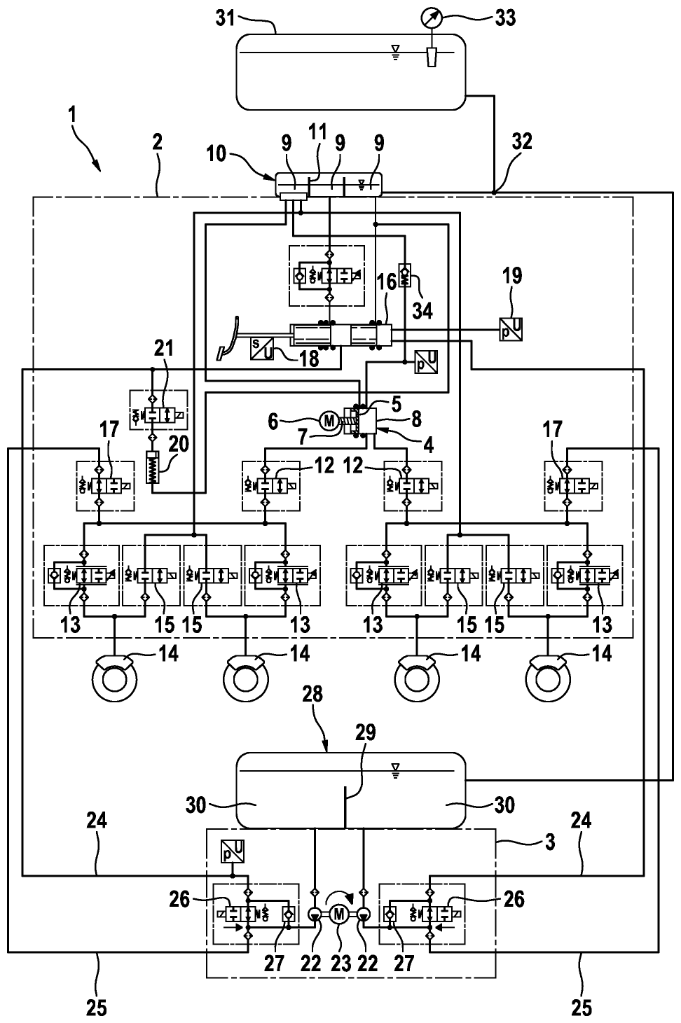

### FIELD

The present invention relates to an electrohydraulic vehicle power braking system for a land vehicle driving autonomously on public roads.

### BACKGROUND INFORMATION

A vehicle power braking system including redundancies which precludes a complete failure of the vehicle braking system with a probability bordering on certainty, without necessitating a driver intervention, is necessary for autonomous driving up to Level 4 (driver may be prompted to intervene) and Level 5 (highest level; no driver required).

German Patent Application No. DE 10 2014 220 440 A1 describes an electrohydraulic vehicle power braking system including two power brake pressure generators, which are hydraulically connected in series. Each brake pressure generator includes an electrically activatable pressure source. Hydraulic wheel brakes are connected to a second of the two brake pressure generators and, indirectly with the aid of the second brake pressure generator, to a first of the two brake pressure generators. If the first brake pressure generator is functional, a brake pressure is hydraulically applied to the wheel brakes, through the second brake pressure generator, by the first brake pressure generator, and the wheel brakes are actuated in this way. The level of the brake pressure is controlled or regulated by the first brake pressure generator. The second brake pressure generator is passive. In the event of a failure of the first brake pressure generator, the second brake pressure generator takes over the brake application.

### SUMMARY

An example electrohydraulic vehicle power braking system according to the present invention is provided for an autonomous driving up to Levels 4 and 5 on public roads. It includes two power brake pressure generators, to which one or multiple hydraulic wheel brake(s) is/are connected. Hydraulic wheel brakes may be connected to both power brake pressure generators and/or the power brake pressure generators include dedicated hydraulic wheel brakes. Embodiments of the vehicle braking system including more than two power brake pressure generators are also possible. A brake pressure for actuating the connected wheel brakes is generatable with the aid of the power brake pressure generators, the brake pressure being regulatable with the aid of the power brake pressure generators and/or with the aid of brake pressure control valve systems. A regulation shall also be understood to mean a control here. In the event of a failure of a power brake pressure generator, a brake application, i.e., an actuation of the wheel brakes which are connected to the other power brake pressure generator, is possible with the aid of the other power brake pressure generator.

According to the present invention, each of the power brake pressure generators includes a brake fluid reservoir. Moreover, the vehicle power braking system includes a further brake fluid reservoir, to which the brake fluid reservoirs of the power brake pressure generators are connected. This increases an availability of the vehicle power braking system according to the present invention in the event of a leak at a generally arbitrary point of the vehicle power braking system.

Advantageous embodiments and refinements of the present invention are described herein.

One embodiment of the present invention provides a design of at least one of the power brake pressure generators as a dual-circuit brake pressure generator, including brake circuits which are hydraulically separated from one another, or at least the connection of two brake circuits which are hydraulically separated from one another to the power brake pressure generator. At least one hydraulic wheel brake is connected to each brake circuit. The dual-circuit design increases the redundancy, and thus the reliability, of the vehicle power braking system according to the present invention and is, in particular, advantageous when a service braking takes place with the aid of one of the two power brake pressure generators, and the other power brake pressure generator is provided for an auxiliary brake application in the event of failure of the one power brake pressure generator. In the event of a fault in one of the two brake circuits, the dual-circuit design of the vehicle power braking system enables a brake application selectively with the aid of one of the two power brake pressure generators.

One preferred embodiment of the present invention provides a brake fluid reservoir, including multiple chambers, for at least one of the power brake pressure generators. The brake fluid reservoir may be divided into multiple chambers by a kind of partition wall, similarly to a conventional multi-chamber brake fluid reservoir of a muscle power-actuated dual-circuit master brake cylinder, for example one brake circuit being connected to one of the chambers. In the event of a leak in one brake circuit, only the assigned chamber of the brake fluid reservoir empties itself, whereas the chamber to which a tight brake circuit is connected does not empty itself. This measure also increases the availability of the vehicle power braking system according to the present invention.

One embodiment of the present invention which is also preferred provides that the further brake fluid reservoir, to which the brake fluid reservoirs of the power brake pressure generators are connected, includes a brake fluid sensor. A brake fluid level, or in any case a drop in the brake fluid level in the further brake fluid reservoir below an established minimum brake fluid level, is measurable with the aid of the brake fluid sensor. A leak of the vehicle power braking system according to the present invention is establishable with the aid of the brake fluid sensor in the further brake fluid reservoir, regardless of where the leak is situated. Only the presence of a leak is establishable, not, however, where it is situated. As a result of each power brake pressure generator including a dedicated brake fluid reservoir, the brake fluid reservoir, or a chamber of the brake fluid reservoir, of a power brake pressure generator to which a tight brake circuit is connected does not lose any brake fluid. The brake fluid sensor in the further brake fluid reservoir is sufficient for identifying a leak at any arbitrary point of the vehicle power braking system according to the present invention, and brake fluid sensors are not necessary in the brake fluid reservoirs of the power brake pressure generators, even though such additional brake fluid sensors in the brake fluid reservoirs of the power brake pressure generators are not precluded.

One embodiment of the present invention provides that a power brake pressure generator includes a power piston-cylinder unit for the brake pressure generation. This refers to a piston-cylinder unit whose piston is movable in the cylinder or, conversely, whose cylinder is movable on the piston, for displacing brake fluid, and thus for the brake pressure generation via an external power. In particular, the piston or the cylinder is moved electromechanically with the aid of an electric motor via a threaded drive or, in general, a rotation/translation transition gear, it being possible for a mechanical reduction gear to be interconnected between the electric motor and the transition gear. Other power drives of the piston or cylinder of the piston-cylinder unit are possible.

One embodiment of the present invention provides a hydraulic pump, in particular, a piston pump or an (internal) gear pump, which, in particular, is driven by an electric motor, as the power brake pressure generator.

A preferred embodiment of the present invention provides that the power piston-cylinder unit and/or the hydraulic pump is/are connected directly, i.e., without interconnection of a hydraulic component, such as a valve, in particular, a solenoid valve, to the brake fluid reservoir. In this way, a low flow resistance from the brake fluid reservoir to the power piston-cylinder unit and/or the hydraulic pump is achieved, which enables a rapid brake pressure build-up, even in the case of a low temperature and, as a result, a viscous brake fluid, and/or in the case of a low ambient pressure. In the event of failure of one of the two power brake pressure generators, the rapid brake pressure build-up is also possible during an auxiliary brake application with the aid of the other power brake pressure generator.

One embodiment of the present invention provides a muscle power or auxiliary power master brake cylinder for a redundant brake pressure generation. Auxiliary power means an actuation of the master brake cylinder with the aid of a brake booster, i.e., an actuation by muscle power boosted by a boosting power of the brake booster. The auxiliary power brake application must not be confused with the auxiliary brake application. The latter is a brake application with the aid of the other power brake pressure generator in the event of failure of the one power brake pressure generator or, in general, a brake application with the aid of redundant components or a redundant system in the event of a failure of one or multiple component(s) or a portion of the vehicle power braking system according to the present invention. The master brake cylinder enables an actuation of the vehicle power braking system during a non-autonomous driving or for a driver intervention during an autonomous driving. The master brake cylinder may serve as a setpoint generator for a power brake application, or the vehicle braking system is actuated by the brake pressure generated with the aid of the master brake cylinder. An auxiliary brake application with the aid of the master brake cylinder is also possible, for example, in the event of a failure of a power brake pressure generator.

One refinement of the present invention provides a brake pressure control valve system for regulating the brake pressure in the wheel brakes or for a wheel-specific brake pressure control in the wheel brakes. The brake pressure control valve system may be designed for slip control units, such as anti-lock braking, traction control and/or vehicle dynamics control units, anti-skid control units, electronic stability programs, for which the abbreviations ABS, TCS, VDC/ESP are common.

All features disclosed in the present description and the figure may be implemented in exemplary embodiments of the present invention either alone or in a generally arbitrary combination. Embodiments of the present invention which do not include all, but only one or multiple features are generally possible.

The present invention is described in greater detail hereafter based on one specific embodiment shown in the figure.

### BRIEF DESCRIPTION OF THE DRAWING

The FIGURE shows a hydraulic circuit diagram of an electrohydraulic vehicle power braking system according to an example embodiment of the present invention.

### DETAILED DESCRIPTION OF EXAMPLE EMBODIMENTS

The electrohydraulic vehicle power braking system 1 according to the present invention shown in the figure is provided for a land vehicle driving autonomously up to Levels 4 and 5 on public roads, namely a passenger car. Level 4 means an autonomous driving, a driver possibly being prompted to intervene, and Level 5, the highest level, means an autonomous driving which requires no driver intervention.

Vehicle power braking system 1 includes two power brake pressure generators 2, 3 which are independent of one another and each include a dedicated energy supply system. One of the two power brake pressure generators 2 includes a power piston-cylinder unit 4 for a brake pressure generation, whose piston 5 is displaceable in a cylinder 8 with the aid of an electric motor 6 via a threaded drive 7, for example a recirculating ball gear, to displace brake fluid from cylinder 8 for a brake actuation and generate the brake pressure. Cylinder 8 of power piston-cylinder unit 4 is connected to a chamber 9 of a brake fluid reservoir 10, which is divided into chambers 9 by partition walls 11. As a result of power piston-cylinder unit 4 being directly connected to brake fluid reservoir 10, a brake line leading from brake fluid reservoir 10 to cylinder 8 of power piston-cylinder unit 4 has a low flow resistance, by which brake fluid flows quickly from brake fluid reservoir 10 into cylinder 8 even if the brake fluid is cold and, as a result, viscous. In the shown and described specific embodiment of the present invention, a check valve 34, through which a flow is possible in the direction of cylinder 8, is situated as an intake valve in the brake line leading from brake fluid reservoir 10 to cylinder 8, which slightly increases the flow resistance.

Four hydraulic wheel brakes 14 are connected to power piston-cylinder unit 4, and thus to the one power brake pressure generator 2, via two power valves 12, which are hydraulically connected in parallel, and four intake valves 13, of which two in each case are hydraulically connected in parallel to the two power valves 12. Starting at power piston-cylinder unit 4, power brake pressure generator 2 is thus divided into two brake circuits which are independent of one another and each include two wheel brakes 14. In the shown and described specific embodiment of the present invention, power valves 12 are closed in their de-energized basic position, and intake valves 13 are 2/2-way solenoid valves which are open in their de-energized basic position, intake valves 13 being designed as proportional valves for enhanced brake pressure control. Power valves 12 are opened, and a brake pressure is generated by displacing piston 5 in cylinder 8 with the aid of electric motor 6, for a power actuation of vehicle braking system 1 or of its wheel brakes 14 with the aid of power piston-cylinder unit 4.

Power brake pressure generator 2 includes one discharge valve 15 for each wheel brake 14, which in the shown and described specific embodiment of the present invention are designed as 2/2-way solenoid valves which are closed in their de-energized basic position, with the aid of which wheel brakes 14 are connected to chambers 9 of brake fluid reservoir 10. Brake fluid reservoir 10 includes a dedicated chamber 9 for each brake circuit and for power piston-cylinder unit 4.

A brake pressure in wheel brakes 14 is selectively regulatable with the aid of electric motor 6 of power piston-cylinder unit 4, and wheel-specifically with the aid of intake valves 13 and discharge valves 15, regulating also to be understood to mean a controlling of the brake pressure. Intake valves 13 and discharge valves 15 form brake pressure control valve systems, with which, in addition to the regulation of the brake pressures in wheel brakes 14, also slip controls, such as anti-lock braking, traction and vehicle dynamics or anti-skid controls, and electronic stability programs, may be carried out, for which the abbreviations ABS, TCS, VDC and ESP are common. Slip control units are conventional to those skilled in the art and are not discussed in greater detail here.

The one power brake pressure generator 2 includes a muscle power-actuatable dual-circuit master brake cylinder 16, to which wheel brakes 14 are connected via a circuit separating valve 17 in each brake circuit and via intake valves 13, so that a brake actuation is also possible with the aid of master brake cylinder 16 using muscle power. In the shown and described specific embodiment of the present invention, circuit separating valves 17 are designed as 2/2-way solenoid valves which are open in their basic position.

For a power brake application, during which the brake pressure is generated with the aid of power piston-cylinder unit 4, master brake cylinder 16 serves as a setpoint generator for the brake pressure to be generated or to be regulated and is separated from intake valves 13 by closing of circuit separating valves 17. A piston travel of a master brake cylinder piston is measured with the aid of a travel sensor 18 and/or a pressure generated in master brake cylinder 16 is measured with the aid of a pressure sensor 19, as the setpoint value for the brake pressure.

To be able to move the master brake cylinder piston or pistons when circuit separating valves 17 are closed, a pedal travel simulator 20 is connected to a brake circuit of master brake cylinder 16 via a simulator valve 21. Simulator valve 21 is closed during a power brake application. Pedal travel simulator 20 is a piston-cylinder unit including a piston acted upon by a spring.

The other power brake pressure generator 3 of electrohydraulic vehicle power braking system 1 according to the present invention is also designed as a dual-circuit brake pressure generator and includes a hydraulic pump 22 in each brake circuit, which are drivable together with the aid of electric motor 23. Hydraulic pumps 22 are, for example, piston pumps or (internal) gear pumps. Suction sides of hydraulic pumps 22 of the other power brake pressure generator 3 are connected via feed brake lines 24 to the two brake circuits of master brake cylinder 16 of the one power brake pressure generator 2, and pressure sides of hydraulic pumps 22 of the other power brake pressure generator 3 are connected via return brake lines 25 at the sides of circuit separating valves 17 of the one power brake pressure generator 2 which face away from intake valves 13.

During a failure of the one power brake pressure generator 2, wheel brakes 14, and thus vehicle power braking system 1, may be actuated with the aid of the other power brake pressure generator 3. A regulation of the wheel brake pressures is possible with the aid of intake valves 13 and discharge valves 15 of the one power brake pressure generator 2. The brake actuation, during a failure of the one power brake pressure generator 2, with the aid of the other power brake pressure generator 3 is a so-called auxiliary brake application.

Bypass valves 26, which in the shown and described specific embodiment of the present invention are designed as 2/2-way solenoid valves which are open in their de-energized basic position, are hydraulically connected in parallel to hydraulic pumps 22 of the other power brake pressure generator 3. They connect master brake cylinder 16 of the one power brake pressure generator 2 to wheel brakes 14 with the aid of circuit separating valves 17 and intake valves 13, so that wheel brakes 14 may be actuated with the aid of master brake cylinder 16. During a power brake application with the aid of the other power brake pressure generator 3, bypass valves 26 are closed.

Check valves 27 are connected hydraulically in parallel to bypass valves 26 of the other power brake pressure generator 3, through which a flow is possible from the suction sides to the pressure side of hydraulic pumps 22, so that an actuation of wheel brakes 14 with the aid of the one power brake pressure generator 2 is even possible when bypass valves 26 are closed.

The other power brake pressure generator 3 includes a dedicated brake fluid reservoir 28, which is divided by a partition wall 29 into two chambers 30, to which the two hydraulic pumps 22 are connected. Hydraulic pumps 22 of the other power brake pressure generator 3 are connected directly, and thus with low flow resistance, to brake fluid reservoir 28, by which a rapid brake pressure build-up is ensured, even when the brake fluid is cold and, as a result, viscous.

Electrohydraulic vehicle power braking system 1 according to the present invention includes a further brake fluid reservoir 31, to which the two brake fluid reservoirs 10, 28 of the two power brake pressure generators 2, 3 are connected via a connection with the aid of a T-piece 32 or a branch. A further brake fluid reservoir 31 which includes a dedicated connection (not shown) for each brake fluid reservoir 10, 28 of power brake pressure generators 2, 3 is also possible. Further brake fluid reservoir 31 does not include any partition walls and is not divided into chambers.

Further brake fluid reservoir 31 includes a brake fluid sensor 33, with the aid of which a brake fluid level is measurable, or a drop in the brake fluid level to or below a predefined minimum brake fluid level is establishable. In this way, a leak of vehicle power braking system 1 is establishable, regardless at which point of vehicle power braking system 1 the leak occurs.

As a result of each power brake pressure generator 2, 3 including a dedicated brake fluid reservoir 10, 28, which additionally are divided into chambers 9, 30, vehicle power braking system 1 according to the present invention is functional in the event of a leak, regardless at which point it occurs, and may be actuated with the aid of at least one of the two power brake pressure generators 2, 3. As a result of the additional division into two brake circuits in both power brake pressure generators 2, 3, the availability of vehicle power braking system 1 is further increased.

The two power brake pressure generators 2, 3 are designed as assemblies, at which brake fluid reservoirs 10, 28 are situated or onto which brake fluid reservoirs 10, 28 are placed, similarly to a conventional master brake cylinder. It is also possible to situate one or both brake fluid reservoir(s) 10, 28 separately from the assemblies. In addition to power piston-cylinder unit 4, the assembly of the one power brake pressure generator 2 includes master brake cylinder 16, brake pressure control valve system including intake valves 13 and discharge valves 15, power valves 12, circuit separating valves 17, and pedal travel simulator 20 including simulator valve 21. The assembly of the other power brake pressure generator 3 includes the two hydraulic pumps 22 including electric motor 23, bypass valves 26, and check valves 27.

1-9. (canceled)

10. An electrohydraulic vehicle power braking system for a land vehicle driving autonomously on public roads, comprising:
two power brake pressure generators to which one or more hydraulic wheel brakes are connected, each of the power brake pressure generator including a respective brake fluid reservoir;
a further brake fluid reservoir to which the brake fluid reservoirs of the power brake pressure generators are connected.

11. The electrohydraulic vehicle power braking system as recited in claim 10, wherein at least one of the power brake pressure generators is a dual-circuit brake pressure generator, including brake circuits which are hydraulically separated from one another and to each of which at least one hydraulic wheel brake is connected.

12. The electrohydraulic vehicle power braking system as recited in claim 10, wherein the respective brake fluid reservoir of at least one of the power brake pressure generators includes multiple chambers.

13. The electrohydraulic vehicle power braking system as recited in claim 10, wherein the further brake fluid reservoir includes a brake fluid sensor.

14. The electrohydraulic vehicle power braking system as recited in claim 10, wherein one of the power brake pressure generators includes a power piston-cylinder unit for brake pressure generation.

15. The electrohydraulic vehicle power braking system as recited in claim 10, wherein one of the power brake pressure generators includes a hydraulic pump for brake pressure generation.

16. The electrohydraulic vehicle power braking system as recited in claim 14, wherein the power piston-cylinder unit is directly connected to the respective brake fluid reservoir of the one of the power brake pressure generators.

17. The electrohydraulic vehicle power braking system as recited in claim 15, wherein the hydraulic pump is directly connected to the respective brake fluid reservoir of the one of the power brake pressure generators.

18. The electrohydraulic vehicle power braking system as recited in claim 10, wherein one of the power brake pressure generators includes a muscle power or auxiliary power master brake cylinder for a redundant brake pressure generation.

19. The electrohydraulic vehicle power braking system as recited in claim 10, wherein one of the power brake pressure generators includes a brake pressure control valve system configured to regulate brake pressures in the wheel brakes, to which the wheel brakes are connected, and the wheel brakes are additionally indirectly connected to the other one of the power brake pressure generators using the brake pressure control valve system.
